(19) United States
(12) Patent Application Publication
(10) Pub. No.: US 2015/0116525 A1
(43) Pub. Date: Apr. 30, 2015

(54) METHOD FOR GENERATING HIGH DYNAMIC RANGE IMAGES

(71) Applicant: Himax Imaging Limited, Tainan City (TW)

(72) Inventor: Yuan-Chih Peng, Tainan City (TW)

(73) Assignee: Himax Imaging Limited, Tainan City (TW)

(21) Appl. No.: 14/068,473

(22) Filed: Oct. 31, 2013

(51) Int. Cl. H04N 5/232

(52) U.S. Cl. CPC H04N 5/23232
USPC 348/218.1

(57) ABSTRACT

The present disclosure provides a method for generating HDR images. Steps of the method include capturing a spatially varying exposure image data of a scene by an image sensing array using a first exposure value and a second exposure value, wherein the first exposure value is larger than the second exposure value; re-sampling the spatially varying exposure image data to obtain a first image data corresponding to the first exposure value and second image data corresponding to the second exposure value; determining a motion index of each pixel of a HDR image data according to the first image data and the second image data; determining a pixel value of each pixel of the HDR image data according to a corresponding first pixel value of the first image data, a corresponding second pixel value of the second image data and the motion index; and outputting the HDR image data.

### BACKGROUND OF THE INVENTION

1. Field of the Invention

The invention relates to an image signal processing technology and more particularly to a technology of generating high dynamic range images.

2. Description of the Related Art

In imaging processing technologies, a ratio of the highest luminance to the lowest luminance of an image is defined as a dynamic range of the image. Take a complementary metal oxide semiconductor (CMOS) image sensor as an example, the dynamic range of an image captured by the CMOS image sensor is limited by the noise floor and the full well capacity, and thus the dynamic range of the image captured by the CMOS image sensor, which may provide 8 bits (256 levels) of brightness information at each pixel, is far less than the dynamic range of the real-world scene sensed by the human eye. The CMOS sensor may adjust exposure time and photosensitivity to fit the scene to be captured. However, if there are both bright regions and dark regions in a scene to be captured, such as a scene with a very large contrast ratio, some image information may not be able to clearly shown. For example, in an image captured with high exposure amount, details in the dark regions may be clear but there is overexposure in the bright regions. In contrast, in an image captured with low exposure amount, details in the bright regions may be clear but the dark regions are too dark and noisy.

In a method for extending the dynamic range of the CMOS image sensor, dark noise is reduced or the full well capacity is improved. In another method for extending the dynamic range of the CMOS image sensor, multiple pixel cells with different photosensitivities are used to generate a high dynamic range image within one capture. Moreover, in still another method for extending the dynamic range of the CMOS image sensor, a plurality of image data obtained with different exposure amounts is combined to generate a high dynamic range image. Nevertheless, other problems may have to be considered when extending the dynamic range in the methods, such as motion blurs, motion artifacts, increase in processing time, and increase in hardware cost.

### BRIEF SUMMARY OF THE INVENTION

In view of this, the invention provides a cost-effective method for generating high dynamic range images without motion blurs and motion artifacts.

In one embodiment, the invention provides a method for generating high dynamic range (HDR) images, comprising: capturing a spatially varying exposure image data of a scene by an image sensing array using a first exposure value and a second exposure value, wherein the first exposure value is larger than the second exposure value; re-sampling the spatially varying exposure image data to obtain a first image data of the scene corresponding to the first exposure value and second image data of the scene corresponding to the second exposure value; determining a motion index of each pixel of a HDR image data according to the first image data and the second image data; determining a pixel value of each pixel of the HDR image data according to a first pixel value of a corresponding pixel of the first image data, a second pixel value of a corresponding pixel of the second image data and the motion index; and outputting the HDR image data.

In another embodiment, the invention provides an apparatus for generating high dynamic range (HDR) images, comprising: an image sensing array, capturing a spatially varying exposure image data of a scene using a first exposure value and a second exposure value, wherein the first exposure value is larger than the second exposure value; and an image processor, coupled to the image sensing array, comprising: a re-sampler, re-sampling the spatially varying exposure image data to obtain a first image data of a scene corresponding to a first exposure value and a second image data of the scene corresponding to a second exposure value; a motion detector, determining a motion index of each pixel of a HDR image data according to the first image data and the second image data; and a saturation detector, determining a pixel value of each pixel of the HDR image data according to a first pixel value of a corresponding pixel of the first image data, a second pixel value of a corresponding pixel of the second image data and the motion index and outputting the HDR image data.

In still another embodiment, the invention provides a computer program product loaded by an electronic apparatus to execute a method for generating high dynamic range images, comprising: a first code, capturing a spatially varying exposure image data of a scene by an image sensing array using a first exposure value and a second exposure value, wherein the first exposure value is larger than the second exposure value; a second code, re-sampling the spatially varying exposure image data to obtain a first image data of the scene corresponding to the first exposure value and second image data of the scene corresponding to the second exposure value; a third code, determining a motion index of each pixel of a HDR image data according to the first image data and the second image data; a fourth code, determining a pixel value of each pixel of the HDR image data according to a first pixel value of a corresponding pixel of the first image data, a second pixel value of a corresponding pixel of the second image data and the motion index; and a fifth code, outputting the HDR image data.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 is a flowchart of method for generating high dynamic range images according to an embodiment of the invention;

FIG. 2A is a block diagram showing an exemplary arrangement of an image sensing array for capturing a spatially varying exposure image data according to an embodiment of the invention;

FIG. 2B is a block diagram showing another exemplary arrangement of an image sensing array for capturing a spatially varying exposure image data according to an embodiment of the invention;

FIG. 3 is a timing diagram showing integration times for different exposure values according to an embodiment of the invention;

FIG. 4 is a block diagram of a spatially varying exposure image data according to an embodiment of the invention;

FIG. 5A is a block diagram of a first image data corresponding to a first exposure value according to an embodiment of the invention;

FIG. 5B is a block diagram of a second image data corresponding to a second exposure value according to an embodiment of the invention;

FIG. 6 is a block diagram of a high dynamic range image data according to an embodiment of the invention;

FIG. 7 is a block diagram showing a relationship between a pixel value difference and a motion index;

FIG. 8 is a block diagram of an apparatus for generating high dynamic range images according to an embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

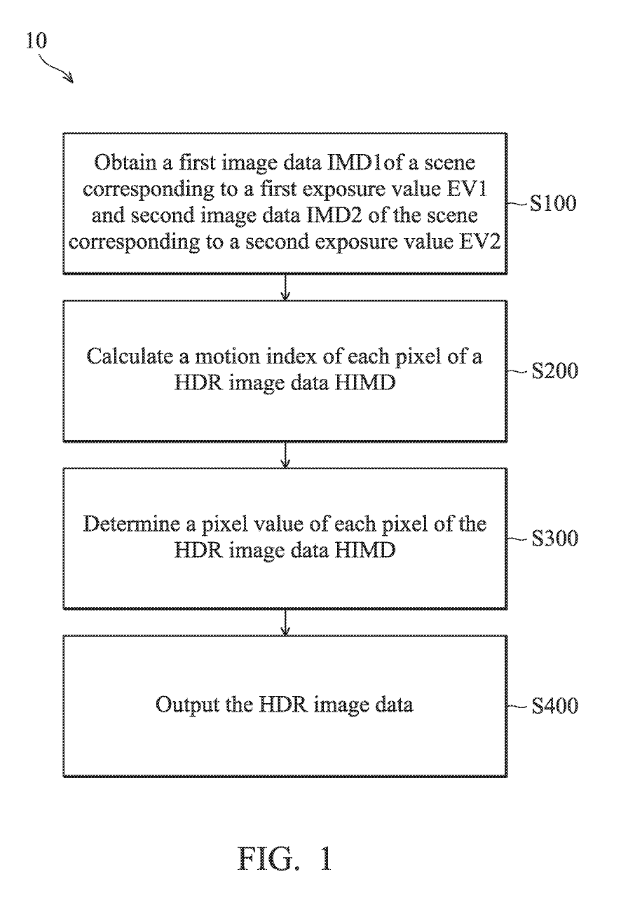

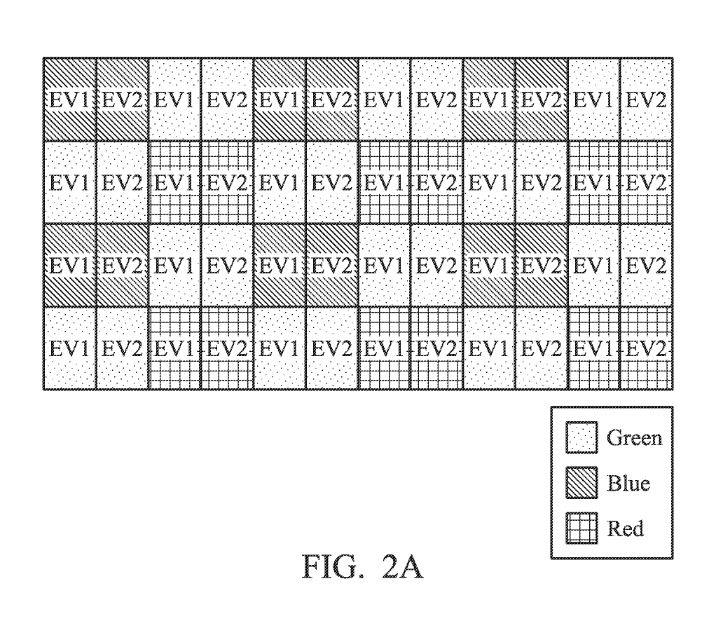

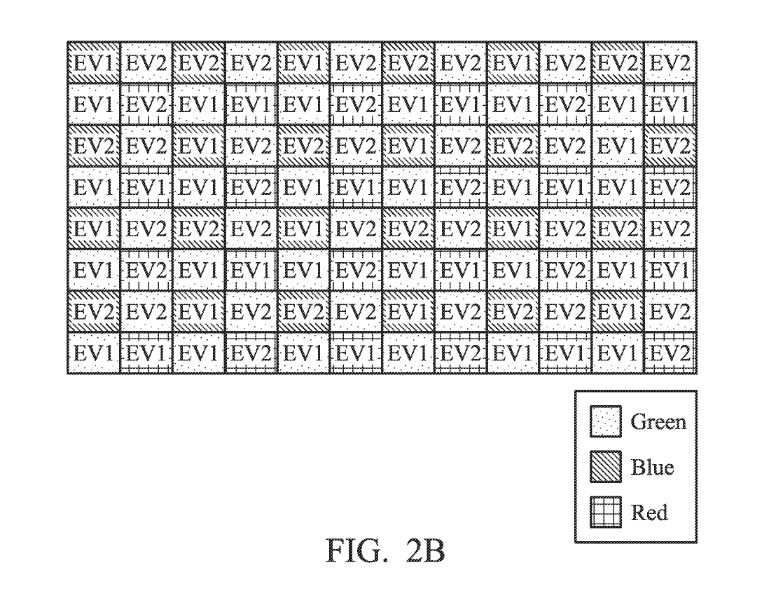

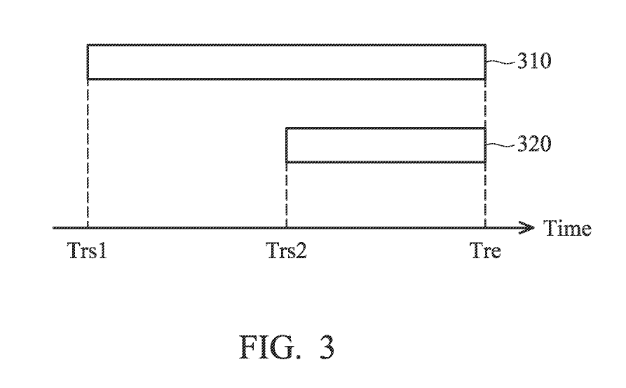

FIG. 1 is a flowchart of method 10 for generating high dynamic range images according to an embodiment of the invention. First, in step S100, a first image data IMD1 of a scene corresponding to a first exposure value EV1 and a second image data IMD2 of the scene corresponding to a second exposure value EV2 are obtained. In the disclosure, the first exposure value EV1 is larger than the second exposure value EV2. The first image data IMD1 and the second image data IMD2 are obtained by re-sampling a spatially exposure image data of the scene captured by an image sensing array, such as a CMOS sensor array, using the first exposure value EV1 and the second exposure value EV2. Referring to FIG. 2A, FIG. 2A is a block diagram showing an exemplary arrangement of the image sensing array for capturing the spatially varying exposure image data according to an embodiment of the invention. The image sensing array is overlaid with a Bayer color filter array. As shown in FIG. 2A, image sensing pixels sense the scene with different exposure values (the first exposure value EV1 and the second exposure value EV2). Note that the invention is not limited to the arrangement of the image sensing array for capturing the spatially varying exposure image data shown in FIG. 2A. For example, FIG. 2B is a block diagram showing another exemplary arrangement of an image sensing array for capturing the spatially varying exposure image data. Since there is no actual shutter in an imaging device comprising a CMOS sensor array, different exposure values are realized by using different integration time (charge storage time). FIG. 3 is a timing diagram showing integration times for different exposure values according to an embodiment of the invention. Sensed data is read out from the CMOS sensor array row by row, therefore, integration times for different exposure values are arranged to end up at the same time point but start at different time points. In FIG. 3, an integration time 310 for the first exposure value EV1 starts at a time point Trs1 and ends up at a time point Tre, while an integration time 320 for the second exposure value EV2 starts at a time point Trs2 and ends up at the time point Tre. For example, in a row of pixels of the CMOS sensor array, pixels arranged to sense data with the first exposure value are reset at the time point Trs1, pixels arranged to sense data with the second exposure value are reset at the time point Trs2, and sensed data of all pixels in the row are read-out at the time point Trs.

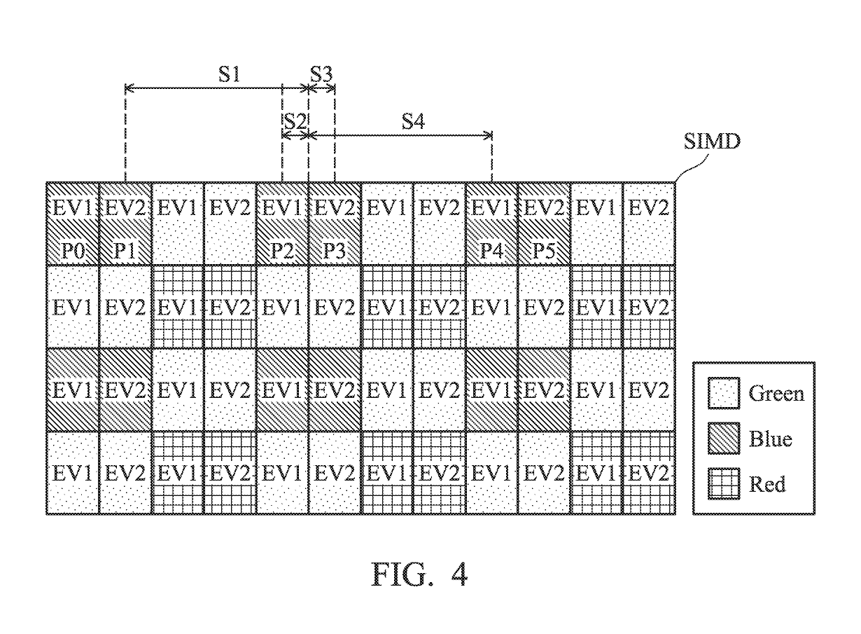

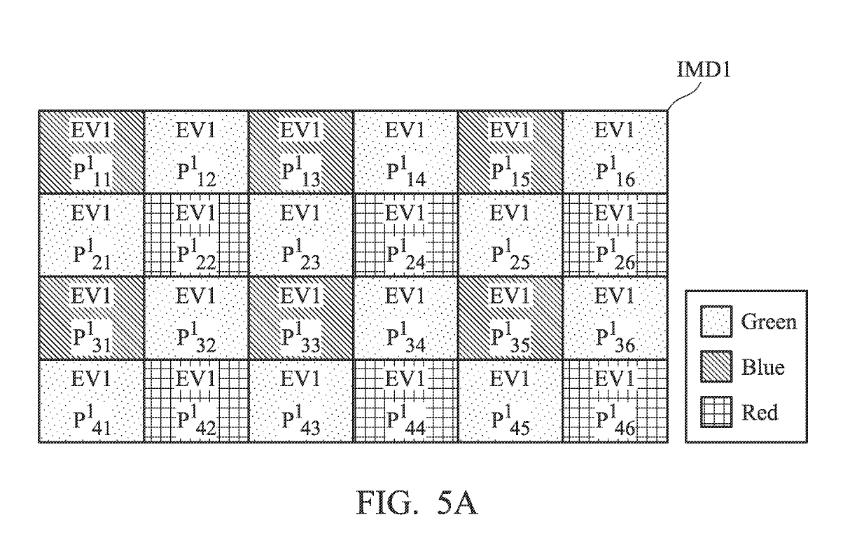

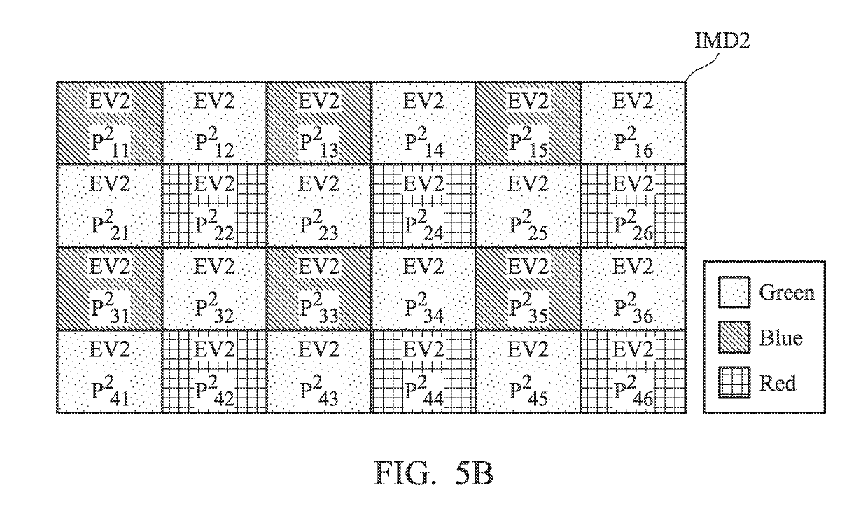

FIG. 4 is a block diagram of a spatially varying exposure image data SIMD according to an embodiment of the invention. The spatially varying exposure image data SIMD is captured by an image sensing array arranged as in FIG. 2A, and each pixel of the spatially varying exposure image data SIMD comprises a pixel value corresponding to one of the first exposure value EV1 and the second exposure value EV2. FIG. 5A is a block diagram of the first image data IMD1 corresponding to the first exposure value EV1. FIG. 5B is a block diagram of the second image data IMD2 corresponding to the second exposure value EV2. The first image data IMD1 and the second image data IMD2 are obtained by re-sampling the spatially exposure image data SIMD in FIG. 4. The first image data IMD1 is a matrix of image data corresponding to the first exposure value EV1 and the second image data IMD2 is a matrix of image data corresponding to the second exposure value EV2. For example, the pixel value of the pixel P¹_{1,3} in the first image data IMD1 in FIG. 5A and the pixel value of the pixel P²_{1,3} in the second image data IMD2 in FIG. 5B are obtained, respectively, from:

$$V ( {P}_{1 , 3}^{1} ) = \frac{S 4}{S 2 + S 4} \times V ( P 2 ) + \frac{S 2}{S 2 + S 4} \times V ( P 4 ) = 0.875 \times V ( P 2 ) + 0.125 \times V ( P 4 ) ;$$

$$and V ( {P}_{1 , 3}^{2} ) = \frac{S 3}{S 1 + S 3} \times V ( P 1 ) + \frac{S 1}{S 1 + S 3} \times V ( P 3 ) = 0.125 \times V ( P 1 ) + 0.875 \times V ( P 3 ) ,$$

wherein Sn denotes a distance between a center position of the pixel Pn and a center position of the pixels P2 and P3, the center position of the pixels P2 and P3 corresponds to a center position of the pixel P¹_{1,3} and a center position of the pixel P²_{1,3}, and V(P) denotes a pixel value of the pixel P. Note that the invention is not limited to the re-sampling method described above. For example, the re-sampling may be adjusted based on the arrangement of the image sensing array for capturing the spatially varying exposure image data.

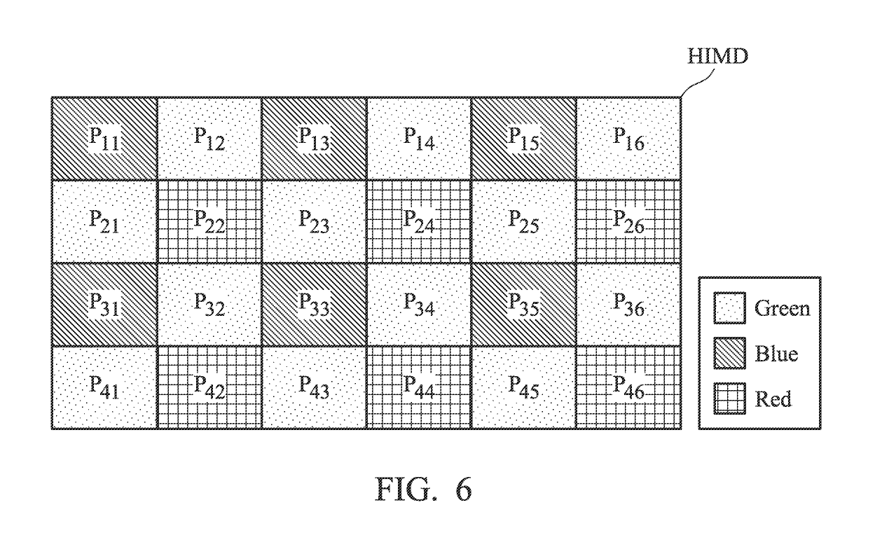

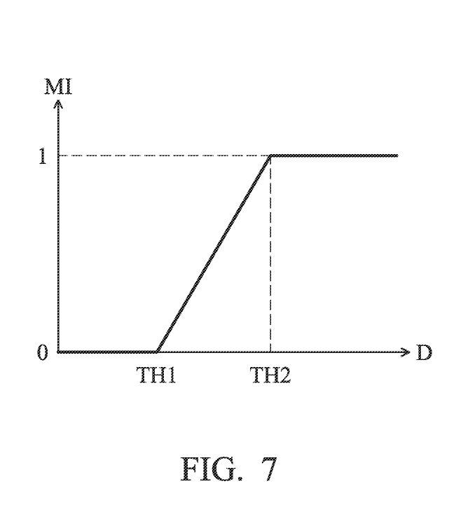

Then, in step S200, a motion index of each pixel of a HDR (High Dynamic Range) image data HIMD is determined according to the first image data IMD1 and the second image data IMD2. FIG. 6 is a block diagram of the HDR image data HIMD according to an embodiment of the invention. The HDR image data HIMD is a matrix of HDR image data. The HDR image data HIMD, the first image data IMD1 and the second image data IMD2 have the same size. The motion index of each pixel of the HDR image data HIMD is determined according to a pixel value difference of each pixel of the HDR image data HIMD and threshold values TH1 and TH2. FIG. 7 is a block diagram showing a relationship between a pixel value difference D and a motion index MI. As shown in FIG. 7, if a pixel value difference of a pixel of the HDR image data HIMD is smaller than or equal to the first threshold value TH1, a motion index of the pixel is 0. If a pixel value difference of a pixel of the HDR image data HIMD is larger than or equal to the second threshold value TH2, a motion index of the pixel 1. Furthermore, if a pixel value difference of a pixel of the HDR image data HIMD is larger than the first threshold value TH1 and smaller than the second threshold value TH2, a motion index of the pixel is a value larger than 0 and smaller than 1, and the larger the pixel value difference is, the larger the motion index is. For example, as depicted in FIG. 7, if a pixel value difference X of a pixel of the HDR image data HIMD is larger than the first threshold value TH1 and smaller than the second threshold value TH2, a motion index of the pixel is equal to

$$\frac{X - TH 1}{TH 2 - TH 1} .$$

The threshold values TH1 and TH2 may be determined base on the noise tolerance. Though the relationship between the motion index and the pixel value difference in an interval of the threshold values TH1 and TH2 is linear in FIG. 7, the invention is not limited thereto.

A pixel value difference of a pixel of the HDR image data HIMD is determined according to the first image data IMD1 and the second image data IMD2. The pixel value difference D_{i,j} of the pixel P_{i,j} of the HDR image data HIMD is calculated according to:

$${D}_{i , j} = 4 \vert V ( {P}_{i , j}^{1} ) - GA \times V ( {P}_{i , j}^{2} ) \vert + 2 ( \begin{matrix}\vert V ( {P}_{i - 1 , j}^{1} ) - GA \times V ( {P}_{i - 1 , j}^{2} ) \vert + \vert V ( {P}_{i + 1 , j}^{1} ) - GA \times V ( {P}_{i + 1 , j}^{2} ) \vert + \\ \vert V ( {P}_{i , j - 1}^{1} ) - GA \times V ( {P}_{i , j - 1}^{2} ) \vert + \vert V ( {P}_{i , j + 1}^{1} ) - GA \times V ( {P}_{i , j + 1}^{2} ) \vert\end{matrix} ) + ( \vert V ( {P}_{i - 1 , j - 1}^{1} ) - GA \times V ( {P}_{i - 1 , j - 1}^{2} ) \vert + \vert V ( {P}_{i - 1 , j + 1}^{1} ) - GA \times V ( {P}_{i - 1 , j + 1}^{2} ) \vert + \vert V ( {P}_{i + 1 , j - 1}^{1} ) - GA \times V ( {P}_{i + 1 , j - 1}^{2} ) \vert + \vert V ( {P}_{i + 1 , j + 1}^{1} ) - GA \times V ( {P}_{i + 1 , j + 1}^{2} ) \vert ,$$

wherein GA denotes an exposure gain and is equal to 2^{EV1-EV2}. Since the first image data IMD1 and the second image data IMD2 are obtained based on different exposure values, second pixel values in the second image data IMD2 have to be multiplied by the exposure gain (i.e., 2^{EV1-EV2}) when calculating the pixel value difference.

Take the pixel P_{3,3} of the HDR image data HIMD in FIG. 6 as an example, the pixel value difference D_{3,3} is calculated according to:

$${D}_{3 , 3} = 4 \vert V ( {P}_{3 , 3}^{1} ) - {2}^{EV 1 - EV 2} \times V ( {P}_{3 , 3}^{2} ) \vert + 2 ( \begin{matrix}\vert V ( {P}_{2 , 3}^{1} ) - {2}^{EV 1 - EV 2} \times V ( {P}_{2 , 3}^{2} ) \vert + \vert V ( {P}_{4 , 3}^{1} ) - {2}^{EV 1 - EV 2} \times V ( {P}_{4 , 3}^{2} ) \vert + \\ \vert V ( {P}_{3 , 2}^{1} ) - {2}^{EV 1 - EV 2} \times V ( {P}_{3 , 2}^{2} ) \vert + \vert V ( {P}_{3 , 4}^{1} ) - {2}^{EV 1 - EV 2} \times V ( {P}_{3 , 4}^{2} ) \vert\end{matrix} ) + ( \vert V ( {P}_{2 , 2}^{1} ) - {2}^{EV 1 - EV 2} \times V ( {P}_{2 , 2}^{2} ) \vert + \vert V ( {P}_{2 , 4}^{1} ) - {2}^{EV 1 - EV 2} \times V ( {P}_{2 , 4}^{2} ) \vert + \vert V ( {P}_{4 , 2}^{1} ) - {2}^{EV 1 - EV 2} \times V ( {P}_{4 , 2}^{2} ) \vert + \vert V ( {P}_{4 , 4}^{1} ) - {2}^{EV 1 - EV 2} \times V ( {P}_{4 , 4}^{2} ) \vert .$$

In step S300, a pixel value of each pixel P_{i,j} of the HDR image data HIMD is determined according to a corresponding first pixel value V(P¹_{1,1}), a corresponding second pixel value V(P²_{1,j}), the motion index M_{i,j} and a saturation threshold value TH. The pixel value V(P_{i,j}) is determined according to:

$$\{ \begin{matrix}V ( {P}_{i , j} ) = {2}^{EV 1 - EV 2} \times V ( {P}_{i , j}^{2} ) , & if V ( {P}_{i , j}^{1} ) \geq TH \\ \begin{matrix}V ( {P}_{i , j} ) = ( 1 - {M}_{i , j} ) \times V ( {P}_{i , j}^{1} ) + \\ {M}_{i , j} \times {2}^{EV 1 - EV 2} \times V ( {P}_{i , j}^{2} ) ,\end{matrix} & if V ( {P}_{i , j}^{1} ) < TH\end{matrix} .$$

If the first pixel value V(P¹_{i,j}) is larger than or equal to the saturation threshold value TH, that is, the pixel P¹_{i,j} has over-exposure, the pixel value V(P_{i,j}) is equal to the second pixel value V(P²_{i,j}) multiplied by the exposure gain. The value of the exposure gain is equal to 2^{EV1-EV2}. On the other hand, if the first pixel value V(P¹_{i,j}) is smaller than the saturation threshold value TH, that is, the pixel P¹_{i,j} doesn't have over-exposure, the pixel value V(P_{i,j}) is a combination of the first pixel value V(P¹_{i,j}) and the second pixel value V(P²_{1,j}) multiplied by the exposure gain based on the motion index M_{i,j} as shown in the equation above.

In step S400, the HDR image data HIMD is outputted. As describe above, in the invention, the motion index M_{i,j} is used to combined the first pixel value V(P¹_{i,j}) and the second pixel value V(P²_{i,j}) multiplied by the exposure gain GA to generate the pixel value V(P_{i,j}) when the first pixel value V(P¹_{i,j}) is smaller than the saturation threshold value TH, instead of directly setting the pixel value V(P_{i,j}) to be the first pixel value V(P¹_{i,j}) when the first pixel value V(P¹_{i,j}) is smaller than the saturation threshold value TH. Therefore, motion blurs and/or motion artifacts can be reduced when generating the HDR image data HIMD in the invention.

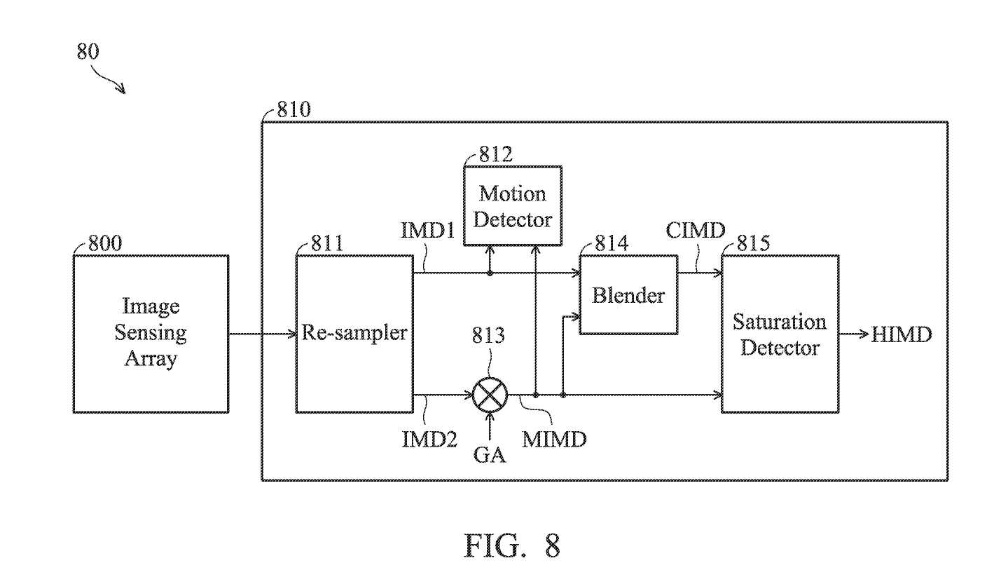

FIG. 8 illustrates a block diagram of an apparatus 80 for generating high dynamic range images according to an embodiment of the invention. The apparatus 80 comprises an image sensing array 800, such as a CMOS sensor array, and an image processor 810 coupled to the image sensing array 800. The image processor 810 comprises a Re-sampler 811, a motion detector 812, a multiplier 813, a blender 814 and a saturation detector 815. The modules in the image processor 810 may comprise image processing hardware, software stored on a non-transitory computer readable medium and executable by a data processor, or a combination thereof, configured to perform functions described below.

The re-sampler 811 re-samples a spatially exposure image data SIMD of a scene captured by the image sensing array 800 using a first exposure value EV1 and a second exposure value EV2 to obtain a first image data IMD1 of the scene corresponding to the first exposure value EV1 and a second image data IMD2 of the scene corresponding to the second exposure value EV2. The details of the spatially exposure image data SIMD, the re-sampling method, the first image data IMD1 and the second image data IMD2 are described above and will no be described again for brevity.

The multiplier 813 multiplies a pixel value of each pixel P²_{i,j} of the second image data IMD2 by an exposure gain GA and generates a multiplied image data MIMD. The value of the exposure gain GA is equal to 2^{EV1-EV2}. Therefore, a pixel value of each pixel P^{M}_{i,j} of the multiplied image data MIMD is equal to the pixel value of each pixel P²_{i,j} of the second image data IMD2 multiplied by the exposure gain GA, that is, V(P_{i,j}^{M})=2^{EV1-EV2}×V(P_{i,j}²). The motion detector 812 determines a motion index M_{i,j} of each pixel P_{i,j} of a HDR image data HIMD according to the first image data IMD1 and the multiplied image data MIMD and outputs the motion index M_{i,j} of each pixel P_{i,j} of the HDR image data HIMD to the blender 814. The detail of determining the motion index is described above and will not be described again for brevity.

The blender 814 receives the first image data IMD1, the multiplied image data MIMD and the motion index M_{i,j} of each pixel P_{i,j} of the HDR image data HIMD and then generates a combined image data CIMD. A pixel value of each pixel P^{C}_{i,j} of the combined image data CIMD is a combination of a pixel value of a corresponding pixel P¹_{i,j} of the first image data IMD1 and a pixel value of a corresponding pixel P^{M}_{i,j} of the multiplied image data MIMD based on the corresponding motion index M_{i,j}, that is, V(P_{i,j}^{C})=(1−M_{i,j})×V(P_{i,j}¹)+M_{i,j}×2^{EV1-EV2}×V(P_{i,j}²). The saturation detector 815 receives the combined image data CIMD and the multiplied image data MIMD, determines a pixel value of each pixel P_{i,j} of the HDR image data HIMD and then outputs the HDR data HIMD. a pixel value of each pixel P_{i,j} of the HDR image data HIMD is determined according to:

$$\{ \begin{matrix}V ( {P}_{i , j} ) = V ( {P}_{i , j}^{M} ) , & if V ( {P}_{i , j}^{1} ) \geq TH \\ V ( {P}_{i , j} ) = V ( {P}_{i , j}^{C} ) , & if V ( {P}_{i , j}^{1} ) < TH\end{matrix} .$$

Other modules of the image processor 810, such as a color demosaicking module, may further process the HDR image data HIMD.

Methods and apparatus of the present disclosure, or certain aspects or portions of embodiments thereof, may take the form of a program code (i.e., instructions) embodied in media, such as floppy diskettes, CD-ROMS, hard drives, firmware, or any other machine-readable storage medium, wherein, when the program code is loaded into and executed by a machine, such as a computer, the machine becomes an apparatus for practicing embodiments of the disclosure. The methods and apparatus of the present disclosure may also be embodied in the form of a program code transmitted over some transmission medium, such as electrical wiring or cabling, through fiber optics, or via any other form of transmission, wherein, when the program code is received and loaded into and executed by a machine, such as a computer, the machine becomes an apparatus for practicing and embodiment of the disclosure. When implemented on a general-purpose processor, the program code combines with the processor to provide a unique apparatus that operates analogously to specific logic circuits.

In one embodiment, the invention provides a computer program product loaded by an electronic apparatus to execute a method for generating high dynamic range images, comprising: a first code, obtaining a first image data of a scene corresponding to a first exposure value and second image data of the scene corresponding to a second exposure value, wherein the first exposure value is larger than the second exposure value; a second code, determining a motion index of each pixel of a HDR image data according to the first image data and the second image data; a third code, determining a pixel value of each pixel of the HDR image data according to a first pixel value of a corresponding pixel of the first image data, a second pixel value of a corresponding pixel of the second image data and the motion index; and a fourth code, outputting the HDR image data. The details of the first image data, the second image data, the motion index and determination of the pixel value of each pixel of the HDR image data are described above and will not be described again for brevity.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method for generating high dynamic range (HDR) images, comprising:
capturing a spatially varying exposure image data of a scene by an image sensing array using a first exposure value and a second exposure value, wherein the first exposure value is larger than the second exposure value;
re-sampling the spatially varying exposure image data to obtain a first image data of the scene corresponding to the first exposure value and second image data of the scene corresponding to the second exposure value;
determining a motion index of each pixel of a HDR image data according to the first image data and the second image data;
determining a pixel value of each pixel of the HDR image data according to a first pixel value of a corresponding pixel of the first image data, a second pixel value of a corresponding pixel of the second image data and the motion index; and
outputting the HDR image data.

2. The method as claimed in claim 1, wherein the motion index M_{i,j} of each pixel P_{i,j} of the HDR image data is determined according to:
if a pixel value difference of each pixel P_{i,j} of the HDR image data is smaller than or equal to a first threshold value, the motion index M_{i,j} is 0;
if the pixel value difference of each pixel P_{i,j} of the HDR image data is larger than or equal to a second threshold value, the motion index M_{i,j} is 1; and
if the pixel value difference of each pixel P_{i,j} of the HDR image data is larger than the first threshold value and smaller than the second threshold value, the motion index M_{i,j} is a value larger than 0 and smaller than 1, wherein the larger the pixel value difference is, the larger the motion index is.

3. The method as claimed in claim 2, wherein the pixel value difference D_{i,j} of each pixel P_{i,j} of the HDR image data is calculated according to:
$${D}_{i , j} = 4 \vert V ( {P}_{i , j}^{1} ) - GA \times V ( {P}_{i , j}^{2} ) \vert + 2 ( \begin{matrix}\vert V ( {P}_{i - 1 , j}^{1} ) - GA \times V ( {P}_{i - 1 , j}^{2} ) \vert + \vert V ( {P}_{i + 1 , j}^{1} ) - GA \times V ( {P}_{i + 1 , j}^{2} ) \vert + \\ \vert V ( {P}_{i , j - 1}^{1} ) - GA \times V ( {P}_{i , j - 1}^{2} ) \vert + \vert V ( {P}_{i , j + 1}^{1} ) - GA \times V ( {P}_{i , j + 1}^{2} ) \vert\end{matrix} ) + ( \begin{matrix}\vert V ( {P}_{i - 1 , j - 1}^{1} ) - GA \times V ( {P}_{i - 1 , j - 1}^{2} ) \vert + \vert V ( {P}_{i - 1 , j + 1}^{1} ) - GA \times V ( {P}_{i - 1 , j + 1}^{2} ) \vert + \\ \vert V ( {P}_{i + 1 , j - 1}^{1} ) - GA \times V ( {P}_{i + 1 , j - 1}^{2} ) \vert + \vert V ( {P}_{i + 1 , j + 1}^{1} ) - GA \times V ( {P}_{i + 1 , j + 1}^{2} ) \vert\end{matrix} ) ,$$
wherein V(P) denotes a pixel value of a pixel P, GA denotes an exposure gain and is equal to 2^{(the first exposure value-the second exposure value)}.

4. The method as claimed in claim 3, wherein the pixel value V(P_{i,j}) of each pixel P_{i,j} of the HDR image data is determined according to:
if the first pixel value is larger than or equal to a saturation threshold value, the pixel value of each pixel P_{i,j} of the HDR image data is equal to the second pixel value multiplied by the exposure gain; and
if the first pixel value is smaller than the saturation threshold value, the pixel value of each pixel P_{i,j} of the HDR image data is equal to (1−M_{i,j})×(the first pixel value)+M_{i,j}×GA×(the second pixel value).

5. An apparatus for generating high dynamic range (HDR) images, comprising:
an image sensing array, capturing a spatially varying exposure image data of a scene using a first exposure value and a second exposure value, wherein the first exposure value is larger than the second exposure value; and
an image processor, coupled to the image sensing array, comprising:
a re-sampler, re-sampling the spatially varying exposure image data to obtain a first image data of a scene corresponding to a first exposure value and a second image data of the scene corresponding to a second exposure value;
a motion detector, determining a motion index of each pixel of a HDR image data according to the first image data and the second image data; and
a saturation detector, determining a pixel value of each pixel of the HDR image data according to a first pixel value of a corresponding pixel of the first image data, a second pixel value of a corresponding pixel of the second image data and the motion index and outputting the HDR image data.

6. The apparatus as claimed in claim 5, wherein the motion index M_{i,j} of each pixel P_{i,j} of the HDR image data is determined by the motion detector according to:
if a pixel value difference of each pixel P_{i,j} of the HDR image data is smaller than or equal to a first threshold value, the motion index M_{i,j} is 0;
if the pixel value difference of each pixel P_{i,j} of the HDR image data is larger than or equal to a second threshold value, the motion index M_{i,j} is 1; and
if the pixel value difference of each pixel P_{i,j} of the HDR image data is larger than the first threshold value and smaller than the second threshold value, the motion index M_{i,j} is a value larger than 0 and smaller than 1, wherein the larger the pixel value difference is, the larger the motion index is.

7. The apparatus as claimed in claim 6, the pixel value difference D_{i,j} of each pixel P_{i,j} of the HDR image data is calculated according to:
$${D}_{i , j} = 4 \vert V ( {P}_{i , j}^{1} ) - GA \times V ( {P}_{i , j}^{2} ) \vert + 2 ( \begin{matrix}\vert V ( {P}_{i - 1 , j}^{1} ) - GA \times V ( {P}_{i - 1 , j}^{2} ) \vert + \vert V ( {P}_{i + 1 , j}^{1} ) - GA \times V ( {P}_{i + 1 , j}^{2} ) \vert + \\ \vert V ( {P}_{i , j - 1}^{1} ) - GA \times V ( {P}_{i , j - 1}^{2} ) \vert + \vert V ( {P}_{i , j + 1}^{1} ) - GA \times V ( {P}_{i , j + 1}^{2} ) \vert\end{matrix} ) + ( \begin{matrix}\vert V ( {P}_{i - 1 , j - 1}^{1} ) - GA \times V ( {P}_{i - 1 , j - 1}^{2} ) \vert + \vert V ( {P}_{i - 1 , j + 1}^{1} ) - GA \times V ( {P}_{i - 1 , j + 1}^{2} ) \vert + \\ \vert V ( {P}_{i + 1 , j - 1}^{1} ) - GA \times V ( {P}_{i + 1 , j - 1}^{2} ) \vert + \vert V ( {P}_{i + 1 , j + 1}^{1} ) - GA \times V ( {P}_{i + 1 , j + 1}^{2} ) \vert\end{matrix} ) ,$$
wherein V(P) denotes a pixel value of a pixel P, GA denotes an exposure gain and is equal to 2^{(the first exposure value-the second exposure value)}.

8. The apparatus as claimed in claim 7, wherein the pixel value V(P_{i,j}) of each pixel P_{i,j} of the HDR image data is determined by the saturation detector according to:
if the first pixel value is larger than or equal to a saturation threshold value, the pixel value of each pixel P_{i,j} of the HDR image data is equal to the second pixel value multiplied by the exposure gain; and
if the first pixel value is smaller than the saturation threshold value, the pixel value of each pixel P_{i,j} of the HDR image data is equal to (1−M_{i,j})×(the first pixel value)+M_{i,j}×GA×(the second pixel value).

9. A computer program product loaded by an electronic apparatus to execute a method for generating high dynamic range images, comprising:
a first code, capturing a spatially varying exposure image data of a scene by an image sensing array using a first exposure value and a second exposure value, wherein the first exposure value is larger than the second exposure value;
a second code, re-sampling the spatially varying exposure image data to obtain a first image data of the scene corresponding to the first exposure value and second image data of the scene corresponding to the second exposure value;
a third code, determining a motion index of each pixel of a HDR image data according to the first image data and the second image data;
a fourth code, determining a pixel value of each pixel of the HDR image data according to a first pixel value of a corresponding pixel of the first image data, a second pixel value of a corresponding pixel of the second image data and the motion index; and
a fifth code, outputting the HDR image data.

10. The program product as claimed in claim 9, wherein the motion index M_{i,j} of each pixel P_{i,j} of the HDR image data is determined according to:
if a pixel value difference of each pixel P_{i,j} of the HDR image data is smaller than or equal to a first threshold value, the motion index M_{i,j} is 0;
if the pixel value difference of each pixel P_{i,j} of the HDR image data is larger than or equal to a second threshold value, the motion index M_{i,j} is 1; and
if the pixel value difference of each pixel P_{i,j} of the HDR image data is larger than the first threshold value and smaller than the second threshold value, the motion index M_{i,j} is a value larger than 0 and smaller than 1, wherein the larger the pixel value difference is, the larger the motion index is.

11. The program product as claimed in claim 10, wherein the pixel value difference D_{i,j} of each pixel P_{i,j} of the HDR image data is calculated according to:
$${D}_{i , j} = 4 \vert V ( {P}_{i , j}^{1} ) - GA \times V ( {P}_{i , j}^{2} ) \vert + 2 ( \begin{matrix}\vert V ( {P}_{i - 1 , j}^{1} ) - GA \times V ( {P}_{i - 1 , j}^{2} ) \vert + \vert V ( {P}_{i + 1 , j}^{1} ) - GA \times V ( {P}_{i + 1 , j}^{2} ) \vert + \\ \vert V ( {P}_{i , j - 1}^{1} ) - GA \times V ( {P}_{i , j - 1}^{2} ) \vert + \vert V ( {P}_{i , j + 1}^{1} ) - GA \times V ( {P}_{i , j + 1}^{2} ) \vert\end{matrix} ) + ( \begin{matrix}\vert V ( {P}_{i - 1 , j - 1}^{1} ) - GA \times V ( {P}_{i - 1 , j - 1}^{2} ) \vert + \vert V ( {P}_{i - 1 , j + 1}^{1} ) - GA \times V ( {P}_{i - 1 , j + 1}^{2} ) \vert + \\ \vert V ( {P}_{i + 1 , j - 1}^{1} ) - GA \times V ( {P}_{i + 1 , j - 1}^{2} ) \vert + \vert V ( {P}_{i + 1 , j + 1}^{1} ) - GA \times V ( {P}_{i + 1 , j + 1}^{2} ) \vert\end{matrix} ) ,$$
wherein V(P) denotes a pixel value of a pixel P, GA denotes an exposure gain and is equal to 2^{(the first exposure value-the second exposure value)}.

12. The program product as claimed in claim 11, wherein the pixel value V(P_{i,j}) of each pixel P_{i,j} of the HDR image data is determined according to:
if the first pixel value is larger than or equal to a saturation threshold value, the pixel value of each pixel P_{i,j} of the HDR image data is equal to the second pixel value multiplied by the exposure gain; and
if the first pixel value is smaller than the saturation threshold value, the pixel value of each pixel P_{i,j} of the HDR image data is equal to (1−M_{i,j})×(the first pixel value)+M_{i,j}×GA×(the second pixel value).
